(19) United States
(12) Patent Application Publication
(10) Pub. No.: US 2019/0217700 A1
(43) Pub. Date: Jul. 18, 2019

(54) TRANSAXLE

(71) Applicant: KANZAKI KOKYUKOKI MFG. CO., LTD., Amagasaki-shi (JP)

(72) Inventors: Takashi NISHIZAWA, Amagasaki-shi (JP); Etsuo MIYAKE, Amagasaki-shi (JP); Tasuku INOUE, Amagasaki-shi (JP)

(21) Appl. No.: 16/363,424

(22) Filed: Mar. 25, 2019

Related U.S. Application Data
(63) Continuation-in-part of application No. 15/366,553, filed on Dec. 1, 2016.

(30) Foreign Application Priority Data
Dec. 4, 2015 (JP) 2015-237901

(51) Int. Cl. B60K 17/12; F16H 1/22; B60K 1/00; B60K 7/00; B60K 17/36

(52) U.S. Cl. CPC B60K 17/12; F16H 1/22; B60K 1/00; B60K 2007/0076; B60K 17/36; B60K 2007/0061; B60K 7/0007

(57) ABSTRACT

A transaxle includes a casing, an axle accommodated in the casing, an electric motor accommodated in the casing, a reduction gear train accommodated in the casing and transmitting an output of the electric motor to the axle, and a bull gear provided on the axle and coupled to the reduction gear train, in which the casing is configured such that a first casing and a second casing are separated and joined at a joint plane parallel to the axle, the bull gear and the axle are supported in the first casing, and the electric motor and the reduction gear train are supported in the second casing.

### CROSS-REFERENCE TO RELATED APPLICATIONS

The present application claims priority under Paris Convention based on Japanese Patent Application No. 2015-237901, filed on Dec. 4, 2015, and is a continuation-in-part of U.S. patent application Ser. No. 15/366, 553, filed on Dec. 1, 2016.

### FIELD

At least one embodiment of this disclosure relates to a transaxle incorporating an electric motor serving as a drive source.

### BACKGROUND

U.S. Pat. No. 6,629,577 Gazette (hereinafter referred to as “'577”) discloses an example of application of a typical hydraulic transaxle to a vehicle. This widely prevailed transaxle accommodates, in a casing supporting a pair of axles, in a compact manner, a differential gear mechanism coupling inner ends of the pair of axles each other to allow the pair of axles to operate in a differential manner, a Hydro Static Transmission (hereinafter referred to as an “HST”) including a hydraulic pump and a hydraulic motor, and a reduction gear train for transmitting output of the HST to the differential gear mechanism. Although an example of application to a lawn tractor is disclosed in “'577,” application aspects vary, such as snow removers, in addition to lawn tractors.

In this typical hydraulic transaxle disclosed in “'577,” an HST chamber accommodating the HST and a gear chamber accommodating the reduction gear train and the differential gear mechanism are formed in the casing. At a center section fastened with bolts at mounting bosses formed on the casing so as to be suspended from a ceiling of the HST chamber, the HST is configured and installed with a hydraulic motor including a horizontal motor shaft parallel to the axles, and a hydraulic pump including a vertical pump shaft. The motor shaft is journalled by a bearing wall portion formed between the HST chamber and the gear chamber, extended into the gear chamber, and drivingly connected to the reduction gear train.

The casing is formed by joining upper and lower housings, where the axles are journalled by the upper housing, and a shaft center of the motor shaft of the hydraulic motor is disposed on a joint plane between the upper and lower housings. Therefore, when installing or removing the HST itself into or from the HST chamber, the motor shaft of the hydraulic motor can easily be installed or removed by separating or joining the upper and lower housings.

Electric motors are required to be used in recent years as power sources of such vehicles for some purposes including energy saving and noise reduction. In connection with these requirements, electric transaxles accommodating, in a casing supporting axles, an electric motor, and a reduction gear train for transmitting output of the electric motor to the axles, as shown in U.S. Pat. No. 8,701,806 Gazette (hereinafter referred to as “'806”), for example, are required to be developed.

As shown in the above “'806”, in the conventional electric transaxle, a casing is configured by joining upper and lower housings, and an axle and an axis of a motor shaft of an electric motor are disposed on a joint plane of the upper and lower housings. In such a configuration, it is necessary to assemble an electric motor, a reduction gear train, a bull gear, and the like to the lower housing in order so that there is a problem that it takes time for assembling work and removal work of each device (the electric motor, the reduction gear train, and the like) accommodated in the casing.

### SUMMARY

A transaxle according to the present application includes a casing, an axle accommodated in the casing, an electric motor accommodated in the casing, a reduction gear train accommodated in the casing and transmitting an output of the electric motor to the axle, and a bull gear provided on the axle and coupled to the reduction gear train. The casing is configured such that a first casing and a second casing are separated and joined at a joint plane parallel to the axle. In the first casing, the bull gear and the axle are supported. In the second casing, the electric motor and the reduction gear train are supported.

The transaxle configured in this manner can be completely divided into members supported by the first casing and members supported by the second casing, and thus, assembling and disassembling of the electric transaxle become easy, and maintenance is improved.

Further, the axle includes a pair of left and right axles coupled in a differential manner by a differential gear mechanism provided on a rotational axis of the bull gear.

Even if the transaxle configured in this manner is an electric transaxle of a dual axle type, the transaxle can be completely divided into members supported by the first casing and members supported by the second casing, and thus, assembling and disassembling become easy, and maintenance is improved.

Further, the first casing is an upper housing which includes a mounting boss configured to attach a transaxle casing to a vehicle body and forms an upper side, and the second casing is a lower housing which forms a lower side.

In the transaxle configured in this manner, the lower housing can be removed in the state of mounting the upper housing side on the vehicle body, and it is possible to easily perform maintenance of the electric motor and the reduction gear train accommodated in the lower housing.

Further, the electric motor is completely supported inside the second casing by a motor base portion formed in the second casing to hold the electric motor and a motor holding member detachably fixed to the motor base portion.

The transaxle configured in this manner can assemble the electric motor to the second casing without worrying about the alignment of the first casing and the second casing, and thus, it is possible to facilitate the work of assembling the electric motor. Since the electric motor can be collectively removed only by separating the first casing and the second casing, the removal work can be facilitated.

Further, a gear shaft of the reduction gear train is completely supported inside the second casing by a bearing base portion formed on the second casing to hold the gear shaft and a bearing holding member detachably fixed to the bearing base portion.

The transaxle configured in this manner can assemble the reduction gear train to the second casing without worrying about the alignment with the first casing side, and thus, it is possible to facilitate the work of assembling the reduction gear train. Since the reduction gear train can be collectively removed only by separating the first casing and the second casing, the removal work can be facilitated.

These and other features and advantages of the embodiment will appear more fully from the following detailed description with reference to the attached drawings.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a side view of a snow remover including a transaxle according to a first embodiment.

FIG. 2 is a side view of the transaxle according to the first embodiment.

FIG. 3 is a plan cross sectional view of the transaxle according to the first embodiment, taken along line and viewed in a direction of arrows shown in FIG. 2.

FIG. 4 is a front cross sectional view of the transaxle according to the first embodiment, taken along line IV-IV and viewed in a direction of arrows shown in FIG. 3.

FIG. 5 is a side cross sectional view of the transaxle according to the first embodiment, taken along line V-V and viewed in a direction of arrows shown in FIG. 3.

FIG. 6 is a partial rear cross sectional view of the transaxle according to the first embodiment, taken along line VI-VI and viewed in a direction of arrows shown in FIG. 4.

FIG. 7 is a perspective view illustrating an attachment aspect of an electric motor on the transaxle according to the first embodiment.

FIG. 8 is a plan cross sectional view of a transaxle according to a second embodiment, viewed in a similar manner to the plan cross sectional view taken along line and viewed in the direction of the arrows shown in FIG. 2.

FIG. 9 is a front cross sectional view of the transaxle according to the second embodiment, taken along line IX-IX and viewed in a direction of arrows shown in FIG. 8.

FIG. 10 is a side cross sectional view of the transaxle according to the second embodiment, taken along line X-X and viewed in a direction of arrows shown in FIG. 9.

FIG. 11 is a plan cross sectional view of a transaxle according to a third embodiment, viewed in a similar manner to the plan cross sectional view taken along line and viewed in the direction of the arrows shown in FIG. 2.

FIG. 12 is a front cross sectional view of the transaxle according to the third embodiment, taken along line XII-XII and viewed in a direction of arrows shown in FIG. 11.

FIG. 13 is a side cross sectional view of the transaxle according to the third embodiment, taken along line XIII-XIII and viewed in a direction of arrows shown in FIG. 12.

FIG. 14 is a perspective view illustrating an attachment aspect of an electric motor on the transaxle according to the third embodiment.

FIG. 15 is a perspective view showing a transaxle according to a fourth embodiment.

FIG. 16 is an exploded perspective view showing a state where the transaxle according to the fourth embodiment is vertically separated.

FIG. 17 is a perspective view in a looking-up direction showing an attachment state of an axle and a bull gear with respect to an upper housing of the transaxle according to the fourth embodiment.

FIG. 18 is a bottom view showing the attachment state of the axle and the bull gear with respect to the upper housing of the transaxle according to the fourth embodiment.

FIG. 19 is a perspective view showing an attachment state of an electric motor and a reduction gear train with respect to a lower housing of the transaxle according to the fourth embodiment.

FIG. 20 is an exploded perspective view showing the attachment state of the electric motor and the reduction gear train with respect to the lower housing of the transaxle according to the fourth embodiment.

FIG. 21 is a partial side view showing a supporting situation of each shaft by a bearing base portion and a bearing holding member of the transaxle according to the fourth embodiment.

FIG. 22 is a plan view showing the attachment state of the electric motor and the reduction gear train with respect to the lower housing of the transaxle according to the fourth embodiment.

FIG. 23 is a perspective view showing the lower housing of the transaxle according to the fourth embodiment.

FIG. 24 is a plan view showing the lower housing of the transaxle according to the fourth embodiment.

FIG. 25 is a plan view showing a linked state of the bull gear and the reduction gear train in the transaxle according to the fourth embodiment.

### DETAILED DESCRIPTION

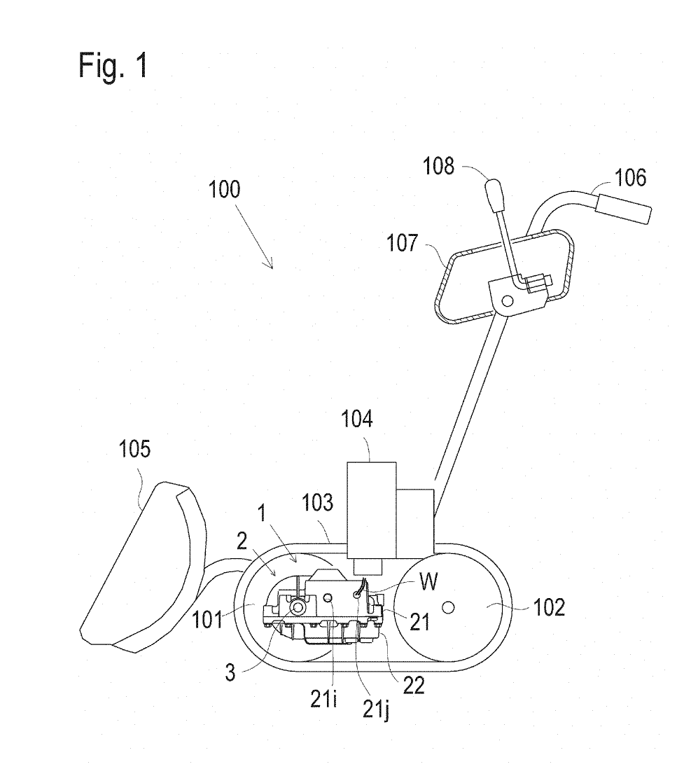

As a typical example of a work vehicle to be applied with a transaxle 1 according to a first embodiment, a snow remover 100 shown in FIG. 1 will now be described herein.

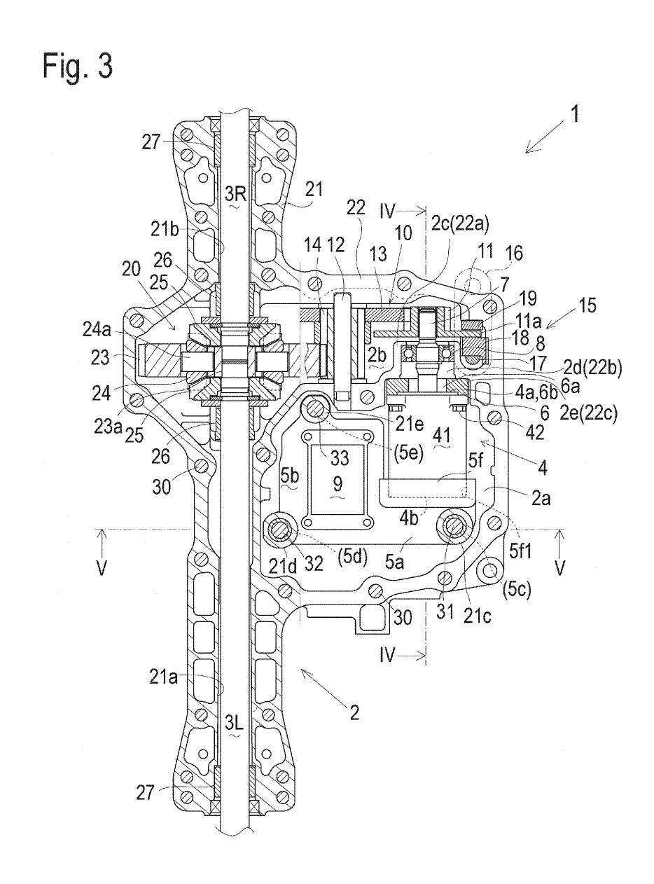

In snow remover 100, transaxle 1 according to the present invention is supported at a front of a vehicle body frame schematically shown in the drawing. Transaxle 1 is an electric transaxle including a transaxle casing 2 for supporting left and right axles 3 (a left axle 3L and a right axle 3R (See FIG. 3)), and for accommodating an electric motor 4 that is a drive source of left and right axles 3, and that will be described later, and other components (See FIG. 3 and other drawings).

Drive sprockets 101 are respectively fixed on outer ends of left and right axles 3 journalled by transaxle casing 2 supported at the front of the vehicle body frame. On the other hand, left and right driven sprockets 102 are journalled at a rear of the vehicle body frame. Crawlers 103 are respectively winded between left drive sprocket 101 and left driven sprocket 102 and between right drive sprocket 101 and right driven sprocket 102.

On the vehicle body frame, a battery 104 that is an energy source for electric motor 4 accommodated in transaxle casing 2 is mounted, and, at the front of the vehicle body frame, a snow removing plate 105 is supported. Left and right handles 106 extend in an upper rear direction from the vehicle body frame. An operation panel 107 is provided between left and right handles 106. On operation panel 107, a gear shifting and forward-backward switching lever 108 for determining a rotational direction and a rotational speed of electric motor 4 is provided.

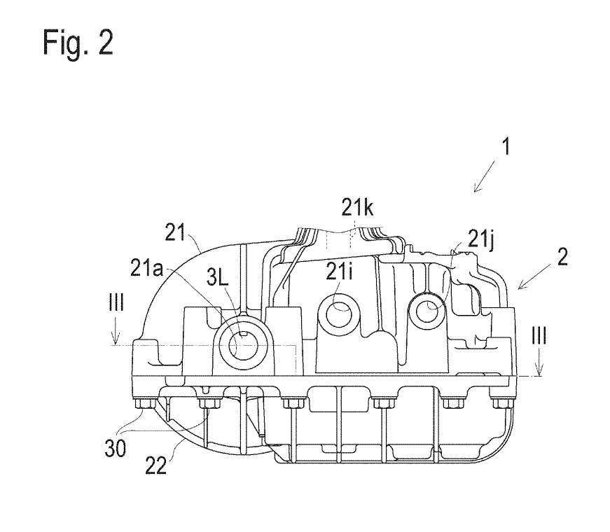

Next, transaxle 1 will now be described herein with reference to FIG. 2 to FIG. 7.

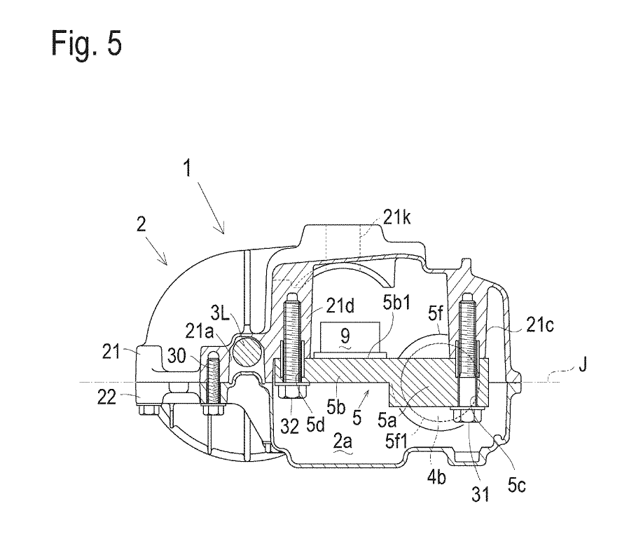

As shown in FIG. 5, transaxle casing 2 of transaxle 1 is configured by tightening with vertical bolts 30 peripheral portions of an upper housing 21 and a lower housing 22 each other joined at a horizontal joint plane J.

On upper housing 21, as shown in FIG. 3, a left axle hole 21a and a right axle hole 21b respectively extending in a horizontal direction on an identical shaft center are formed. Left axle 3L is inserted into left axle hole 21a, and right axle 3R is inserted into right axle hole 21b. Left and right axles 3L and 3R are both journalled by upper housing 21 via radial bearings 27 each provided at outer end portions of left and right axle holes 21a and 21b.

Inside transaxle casing 2 formed by joining upper and lower housings 21 and 22, a gear chamber 2b extending in a direction that is a front-back direction of snow remover 100 is formed, where left axle hole 21a extends leftward from a front of gear chamber 2b, and right axle hole 21b extends rightward from the front of gear chamber 2b.

Behind left axle hole 21a, a motor chamber 2a is formed so as to position next to left of a rear of gear chamber 2b. Between motor chamber 2a and gear chamber 2b, a partition wall 2c configured by upper and lower housings 21 and 22 is formed to extend in an approximately front-back direction.

Although above descriptions regarding directions and positions of members and portions premise that, in snow remover 100, support portions of axles 3 in transaxle casing 2 are disposed forward from motor chamber 2a in transaxle casing 2, transaxle 1 may be applied to a vehicle such that the support portions of axles 3 in transaxle casing 2 are disposed behind motor chamber 2a in transaxle casing 2.

In addition, transaxle 1 may be applied such that upper housing 21 and lower housing 22 are vertically inverted, transaxle 1 may be provided such that housings 21 and 22 are disposed in a front-back direction (so as to become perpendicular to joint plane J), or transaxle 1 may be applied with other forms.

This can also be said to a transaxle 51 according to a second embodiment and a transaxle 61 according to a third embodiment to be described later.

At the front of gear chamber 2b, a differential gear mechanism 20 that couples in a differential manner inner ends of left and right axles 3L and 3R is accommodated. Differential gear mechanism 20 is formed by combining a bull gear 23, bevel differential pinions 24, and a left and right pair of bevel differential side gears 25.

At a center of bull gear 23, a shaft hole 23a is provided in a horizontal direction. Inner end portions of left axle 3L and right axle 3R are engaged into shaft hole 23a. Along left and right side faces of bull gear 23, bevel differential side gears 25 are respectively fixed on left and right axles 3L and 3R. On bull gear 23, a pair of pinion holes is symmetrically formed around shaft hole 23a, as shown in FIG. 3, for example, and, in each of the pinion holes, bevel differential pinions 24 are respectively pivot-supported via pinion shafts 24a. Bevel differential pinions 24 respectively engage left and right bevel differential side gears 25.

Near outsides on left and right of bevel differential side gears 25 in gear chamber 2b, axles 3L and 3R are journalled by radial bearings 26.

On the other hand, as shown in FIG. 3 to FIG. 5, in motor chamber 2a, three mounting bosses 21c, 21d, and 21e are formed on upper housing 21 so as to be suspended downwardly from a portion regarded as a ceiling of motor chamber 2a. Mounting bosses 21c, 21d, and 21e respectively include a vertical bolt hole (screw hole) perpendicular to joint plane J. Lower end surfaces of mounting bosses 21c, 21d, and 21e where lower ends of bolt holes open are horizontal surfaces and all arranged at identical heights.

Mounting boss 21c is disposed at a rear left corner of motor chamber 2a. Mounting boss 21d is disposed at a front left corner of motor chamber 2a. Mounting boss 21e is disposed at a front right corner of motor chamber 2a. Mounting bosses 21c and 21d are arranged on an approximately straight line in a front-back direction along a left end wall of motor chamber 2a. A motor support member 5 is fastened with bolts to and supported by these three mounting bosses 21c, 21d, and 21e.

Motor support member 5 is an entirely flat plate material. A rear half portion of motor support member 5 is a motor support portion 5a extending in a front-back direction, having a narrow width in a horizontal direction, and forming, at its right end, a vertical, disk-shaped motor boss portion 5f having a recess 5f1 opening rightward. A front half portion of motor support member 5 is a horizontal plate-shaped electrical component support portion 5b swelled rightward than motor boss portion 5f formed at a right end of motor support portion 5a, i.e. the rear half portion of motor support member 5, and its flat top surface is served as a horizontal electrical component mounting surface 5b1 parallel to joint plane J.

On motor support member 5, a rear end portion of motor support portion 5a, and a left front portion and a right front portion of electrical component support portion 5b are respectively formed with vertical bolt holes 5c, 5d, and 5e. A horizontal surface of motor support member 5 where upper ends of bolt holes 5c, 5d, and 5e open is a surface flush to electrical component mounting surface 5b1. By joining this surface with the lower end surfaces of mounting bosses 21c, 21d, and 21e, bolt holes 5c, 5d, and 5e align with the bolt holes of mounting bosses 21c, 21d, and 21e as will be described later.

Electrical component mounting surface 5b1 is installed with a relay 9 in this embodiment. However, instead of (or in addition to) relay 9, other electrical components including an inverter may be installed. In this manner, “relay 9” described below is replaceable with other electrical components including an inverter.

Since electrical component support portion 5b including electrical component mounting surface 5b1 positions close to electric motor 4 supported by motor support portion 5a of motor support member 5 as will be described later, a wiring distance between relay 9 installed in here and electric motor 4 can be reduced. Thus, installation of electric motor 4 and relay 9 as a set into motor chamber 2a can be easier.

Electric motor 4 includes a cylindrical motor casing 41 accommodating a stator and a rotor (not shown in the drawings). Motor output shaft 7 extends from an end of motor casing 41. An end portion of motor casing 41 from which motor output shaft 7 extends is served as a first end portion 4a of electric motor 4, and an opposite end portion of motor casing 41 from which motor output shaft 7 does not extend is served as a second end portion 4b of electric motor 4.

On electric motor 4, a plurality of tabs 41a (four in this embodiment) are further formed to protrude outwardly in diameter directions from an outer peripheral surface of motor casing 41 near first end portion 4a. Each of tabs 41a is formed with a screw hole passing in a horizontal direction.

A motor mount member 6 is used to assemble electric motor 4 into transaxle casing 2. Motor mount member 6 is a vertical plate-shaped member including rectangular left and right side faces, where, on its upper end portion and lower end portion, locking pieces 6d and 6e are symmetrically formed. A center of motor mount member 6 is formed in a vertical plate shape parallel to vertical plate-shaped motor boss portion 5f of motor support member 5. At the center of motor mount member 6, a motor shaft hole 6a passing in a horizontal direction is formed, where a right end portion of motor shaft hole 6a is increased in diameter to form a circular recess 6b. Around recess 6b, screw holes 6c are formed at positions corresponding to tabs 41a.

As shown in FIG. 7 and other drawings, by engaging first end portion 4a of electric motor 4 into recess 6b of motor mount member 6, motor output shaft 7 is inserted into motor shaft hole 6a. In addition, by allowing tabs 41a and a left side face of motor mount member 6 to abut, and inserting screws 42 into screw holes of tabs 41a, and further threading screws 42 into screw holes 6c of motor mount member 6, electric motor 4 is fixed, at its first end portion 4a, to motor mount member 6. Motor output shaft 7 inserted into motor shaft hole 6a further extends rightward from a right side face of motor mount member 6, and a bearing 8 is provided around this rightward-extended portion.

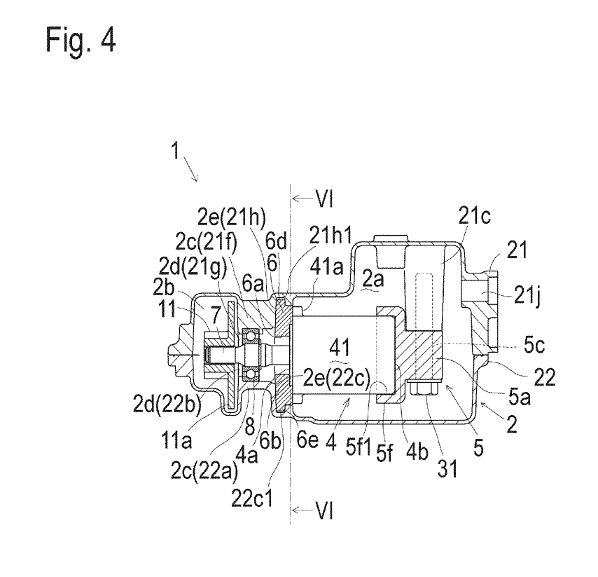

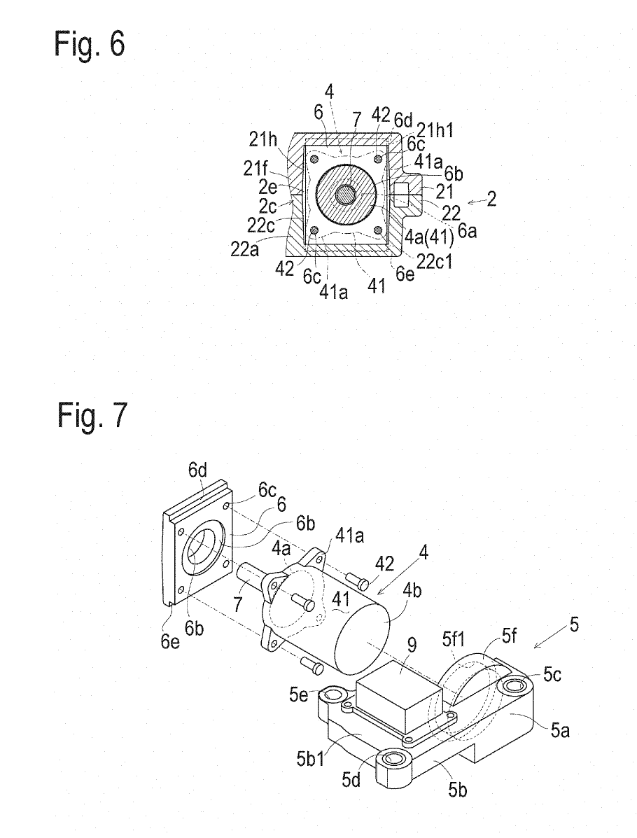

As shown in FIG. 4 and FIG. 6 and other drawings, partition wall 2c formed between motor chamber 2a and gear chamber 2b is configured by joining an upper partition wall portion 21f formed on upper housing 21 and a lower partition wall portion 22a formed on lower housing 22 when joining upper and lower housings 21 and 22.

On upper partition wall portion 21f, an approximately half-cylindrical recess 21g is formed. Around a left end portion of recess 21g facing motor chamber 2a, a cut-away section 21h having an approximately rectangular shape when viewed from a side is also formed. Along a top edge of cut-away section 21h, a locking groove 21h1 is formed. On the other hand, lower partition wall portion 22a is also formed with an approximately half-cylindrical recess 22b. Around a left end portion of recess 22b facing motor chamber 2a, a cut-away section 22c having an approximately rectangular shape when viewed from a side is also formed. Along a lower edge of cut-away section 22c, a locking groove 22c1 is also formed.

Before joining upper housing 21 and lower housing 22, as described above, a half portion of an outer peripheral surface of bearing 8 mounted on motor output shaft 7 protruded from motor mount member 6 attached with first end portion 4a of electric motor 4 is joined to an inner peripheral surface of recess 21g of upper housing 21, and a side of a locking piece 6d of motor mount member 6 is engaged into locking groove 21h1 to fit an upper half portion of motor mount member 6 to cut-away section 21h.

Further, as described above, by aligning each of the bolt holes of mounting bosses 21c, 21d, and 21e with bolt holes 5c, 5d, and 5e of motor support member 5 attached with second end portion 4b of electric motor 4, and threading bolts 31, 32, and 33 into mounting bosses 21c, 21d, and 21e via bolt holes 5c, 5d, and 5e, electric motor 4, motor support member 5, and motor mount member 6 are positioned and installed in upper housing 21.

When joining lower housing 22 to upper housing 21 configured as described above, a remaining half portion of the outer peripheral surface of bearing 8 is joined to an inner peripheral surface of recess 22b of lower housing 21, and another side of locking piece 6e of motor mount member 6 is engaged into locking groove 22c1 to fit a lower half portion of motor mount member 6 to cut-away section 22c.

When upper partition wall portion 21f and lower partition wall portion 22a join as described above, recess 21g and recess 22b align to form an approximately cylindrical motor shaft hole 2d passing through partition wall 2c. In this motor shaft hole 2d, motor output shaft 7 is journalled by transaxle casing 2 via bearing 8.

After cut-away section 21h and cut-away section 22c align, a cut-away section 2e having an approximately rectangular shape when viewed from a rear is formed on partition wall 2c, as shown in FIG. 6 and other drawings. Motor mount member 6 attached with first end portion 4a of electric motor 4 is engaged into this cut-away section 2e. In this state, while locking pieces 6d and 6e are engaged into locking grooves 21h1 and 22c1 of upper and lower housings 21 and 22, motor mount member 6 is locked to transaxle casing 2.

That is, motor support member 5 attached with second end portion 4b of electric motor 4 is fastened by only upper housing 21. On the other hand, motor mount member 6 attached with first end portion 4a of electric motor 4 is clamped and locked by upper housing 21 and lower housing 22.

As described above, electric motor 4 has been assembled into motor chamber 2a of transaxle casing 2. In this state, a right end portion of motor output shaft 7 of electric motor 4 is disposed in a rear portion of gear chamber 2b via motor shaft hole 2d.

In the rear portion of gear chamber 2b, reduction gear mechanism 10 for transmitting rotational power of motor output shaft 7 to differential gear mechanism 20 is accommodated. Reduction gear mechanism 10 includes a motor output gear 11, a counter shaft 12, and a large diameter counter gear 13 and a small diameter counter gear 14 provided around counter shaft 12.

Between a right portion of motor output shaft 7 disposed in gear chamber 2b and differential gear mechanism 20, counter shaft 12 extends in parallel to motor output shaft 7 and axles 3L and 3R, as described above, and its shaft center is disposed on joint plane J as described above.

That is, as described above, when upper housing 21 and lower housing 22 join at joint plane J, a right end portion of counter shaft 12 is clamped between a right wall portion of upper housing 21 and a right wall portion of lower housing 22, and a left end portion of counter shaft 12 is clamped between upper partition wall portion 21f of upper housing 21 and lower partition wall portion 22a of lower housing 22.

Counter shaft 12 is attached with small diameter counter gear 14 having a cylindrical shape ranging from a left end to a right end of gear chamber 2b to engage bull gear 23 of differential gear mechanism 20. Small diameter counter gear 14 is fixed with large diameter counter gear 13 to engage motor output gear 11. In such a manner, gears 11, 13, 14, and 23 configures a reduction gear train.

Motor output gear 11 is formed with a brake disk 11a. In gear chamber 2b, a brake shoe 18 and a brake pad 19 are provided so as to pinch brake disk 11a. Opposite to brake disk 11a with brake shoe 18 interposed, a vertical brake camshaft 17 is provided.

Brake camshaft 17 is rotatably supported around its vertical shaft center by transaxle casing 2 (upper housing 21 and/or lower housing 22). Its upper end or lower end is disposed outside transaxle casing 2. A brake arm 16 is fixed to an end portion of this brake camshaft 17. Brake arm 16 is linked to a brake operation tool such as a brake lever (not shown in the drawings) provided on either of handles 106 of snow remover 100.

By operating the brake operation tool to rotate brake arm 16 and brake camshaft 17, brake shoe 18 presses brake disk 11a onto brake pad 19 to apply a brake to motor output shaft 7, and thus a brake is applied to axles 3.

As described above, brake disk 11a, brake arm 16, brake camshaft 17, brake shoe 18, brake pad 19, and other components configure a brake 15 for motor output shaft 7.

Electric motor 4 can rotate reversely. Thus, by determining a rotational direction through an operation of gear shifting and forward-backward switching lever 108, electric motor 4 can drive axles 3 forward or backward. Electric motor 4 is adjustable in its rotational speed through a voltage control or another control in accordance with an operation position of gear shifting and forward-backward switching lever 108, and drives axles 3 at a speed corresponding to the adjusted rotational speed.

That is, transaxle 1 according to the first embodiment includes axles 3, transaxle casing 2 that supports axles 3, and that is internally formed with motor chamber 2a and gear chamber 2b, electric motor 4 accommodated in motor chamber 2a, and reduction gear mechanism 10 accommodated in gear chamber 2b to transmit output of electric motor 4 to axles 3.

In transaxle casing 2, mounting bosses 21c, 21d, and 21e are formed in motor chamber 2a so as to be suspended from the ceiling of motor chamber 2a. In motor chamber 2a, motor support member 5 fastened with bolts 31, 32, and 33 to mounting bosses 21c, 21d, and 21e is provided.

Electric motor 4 includes first end portion 4a from which motor output shaft 7 protrudes, and second end portion 4b opposite to first end portion 4a. Motor output shaft 7 is journalled by partition wall 2c formed between motor chamber 2a and gear chamber 2b in transaxle casing 2, extended into gear chamber 2b, and, in gear chamber 2b, drivingly connected to reduction gear mechanism 10. Electric motor 4 is supported in motor chamber 2a with its second end portion 4b locked to motor support member 5.

By using as they are a transaxle casing 2, axles 3, a reduction gear mechanism 10, a brake 15, and a differential gear mechanism 20 of a conventional hydraulic transaxle as disclosed in “'577,” and diverting a chamber served as an HST chamber for accommodating an HST in transaxle casing 2 into a motor chamber 2a for accommodating an electric motor 4 and a relay 9, an electric transaxle 1 configured as described above can be configured easily in a cost effective manner.

When second end portion 4b of electric motor 4 is supported, which is opposite to first end portion 4a from which motor output shaft 7 protrudes, motor support member 5 for supporting second end portion 4b of electric motor 4 can be supported, when accommodating an HST, by using as they are mounting bosses 21c, 21d, and 21e used to support a center section (oil passage plate) of the HST.

In transaxle 1 according to the first embodiment, motor support member 5 is formed with a plate-shaped motor boss portion 5f for locking second end portion 4b of electric motor 4. This motor support member 5 is further formed with, perpendicular to motor boss portion 5f, a plate-shaped electrical component support portion 5b for supporting the electrical components including relay 9 connected to electric motor 4.

As described above, electric motor 4 with which horizontal motor output shaft 7 extends into gear chamber 2b can be provided by utilizing as is a space for providing a hydraulic motor including a horizontal motor shaft, which is included in an HST. On the other hand, the electrical components including relay 9 can be disposed by utilizing as is a space for disposing a hydraulic pump including a vertical pump shaft, which is conventionally disposed between a hydraulic motor and a support portion for axles 3 in transaxle casing 2 in front of the hydraulic motor.

That is, not only electric motor 4, but also relay 9 (and (or) other electrical components including an inverter) can be accommodated in motor chamber 2a configured to conform to a layout of a conventional HST in a compact manner without wasting any space.

In addition, motor support member 5 fastened with bolts to mounting bosses 21c, 21d, and 21e for supporting second end portion 4b of electric motor 4 and relay 9 can be configured in a cost effective manner by utilizing, for example, a mold modified based on a mold used for the oil passage plate, since its entire shape will naturally become similar to an entire shape of an oil passage plate used in a conventional hydraulic transaxle.

In addition, in transaxle 1 according to the first embodiment, transaxle casing 2 is formed by joining upper and lower housings 21 and 22 at joint plane J, where electrical component mounting surface 5b1 of electrical component support portion 5b of motor support member 5, which is used for supporting relay 9, is disposed horizontally and in parallel to joint plane J.

Therefore, by separating or joining housings 21 and 22 each other at joint plane J, relay 9 that is one of the electrical components can be easily installed or removed when removing or installing electric motor 4 from or into motor chamber 2a. In addition, electrical component mounting surface 5b1 of motor support member 5 can be securely and widely provided for attaching the electrical components including relay 9 by disposing electrical component mounting surface 5b1 in parallel to joint plane J.

A shaft center of motor output shaft 7 is further disposed on joint plane J. By separating or joining housings 21 and 22 each other, motor output shaft 7 can easily be installed or removed when installing or removing electric motor 4 into or from motor chamber 2a.

In addition, since electric motor 4 and relay 9 that is one of the electrical components are arranged in parallel along joint plane J and supported by motor support member 5, a width of a space required for disposing electric motor 4 and electrical components 9 in a vertical direction perpendicular to joint plane J can be minimized. As a result, in motor chamber 2a in transaxle casing 2, where a height is limited, electric motor 4 and relay 9 can be provided advantageously in terms of assembly, maintenance, and other tasks.

In transaxle 1 according to the first embodiment, electric motor 4 is locked to partition wall 2c of transaxle casing 2.

Therefore, a partition wall 2c provided in a casing of a conventional hydraulic transaxle for journalling a motor shaft of a hydraulic motor can be used as is and served as a portion for locking first end portion 4a of electric motor 4. A space for disposing electric motor 4 in gear chamber 2a in a shaft center direction of motor output shaft 7 can further be reduced.

Transaxle 1 further includes motor mount member 6 including a plate-shaped portion parallel to motor boss portion 5f of motor support member 5. First end portion 4a of electric motor 4 is locked to partition wall 2c via the plate-shaped portion of motor mount member 6.

As described above, motor mount member 6 for locking first end portion 4a of electric motor 4 is a member including the plate-shaped portion parallel to motor boss portion 5f of motor support member 5. With its simple configuration, where partition wall 2c of transaxle casing 2 is also a vertical wall parallel to motor boss portion 5f, partition wall 2c for fitting motor mount member 6 can be additionally machined simply without requiring an increased cost.

As described above, with transaxle 1 incorporated with electric motor 4, according to the first embodiment, a casing of a conventional hydraulic transaxle, which is formed by joining upper and lower housings 21 and 22, can be utilized as is as transaxle casing 2, and thus its production cost can be reduced.

On upper housing 21 of transaxle casing 2, as shown in FIG. 2, boss holes 21i and 21j opening outwardly from motor chamber 2a are formed in a left-and-right, horizontal direction.

When an HST is accommodated in motor chamber 2a, these boss holes are served as boss holes for journalling a trunnion shaft for movable swash plates of a hydraulic pump including a vertical pump shaft, or boss holes for supporting a pin clamped by a neutral return spring. However, similar to electric transaxle 1 according to this embodiment, when electric motor 4 and relay 9 are accommodated in motor chamber 2a, boss hole 21i or 21j can be used, as shown in FIG. 1, as a hole for passing through a wire W to be connected to relay 9. An unused boss hole may be plugged with a plug.

Furthermore, since a shaft hole 21k is formed on an upper end portion of upper housing 21 of transaxle casing 2 for journalling a vertical pump shaft of a hydraulic pump of an HST when a transaxle is served as a hydraulic transaxle, this shaft hole 21k may be used for inserting wire W.

By using motor chamber 2a as a moist chamber, more efficient cooling of electrical components including electric motor 4 and relay 9 disposed in motor chamber 2a can be expected.

In transaxle casing 2 served as a casing of a hydraulic transaxle, an oil passage has conventionally been formed in partition wall 2c to allow oil to communicate between motor chamber 2a and gear chamber 2b so as to share the oil in lubricating and operating an HST disposed in motor chamber 2a, and in lubricating gears in gear chamber 2b.

In addition, in order to prevent the HST in motor chamber 2a from being impaired in operation due to the oil mixed with iron powder generated from gears engaged in gear chamber 2b when the oil flows from gear chamber 2b into motor chamber 2a through this oil passage, a magnet formed in a disk shape or another shape has conventionally been provided and disposed near an inlet of the oil passage in gear chamber 2b in transaxle casing 2, for example.

Therefore, when disposing electric motor 4 in motor chamber 2a, instead of an HST, similar to transaxle 1 according to this embodiment, the oil passage on partition wall 2c can be used to introduce into motor chamber 2a gear lubricating oil used in gear chamber 2b as cooling oil for electric motor 4 and other components. In addition, the magnet can be served as is to prevent iron powder mixed in oil in gear chamber 2b from being mixed into the oil introduced into motor chamber 2a. As a result, motor chamber 2a can be provided as a moist chamber presenting superior cooling efficiency.

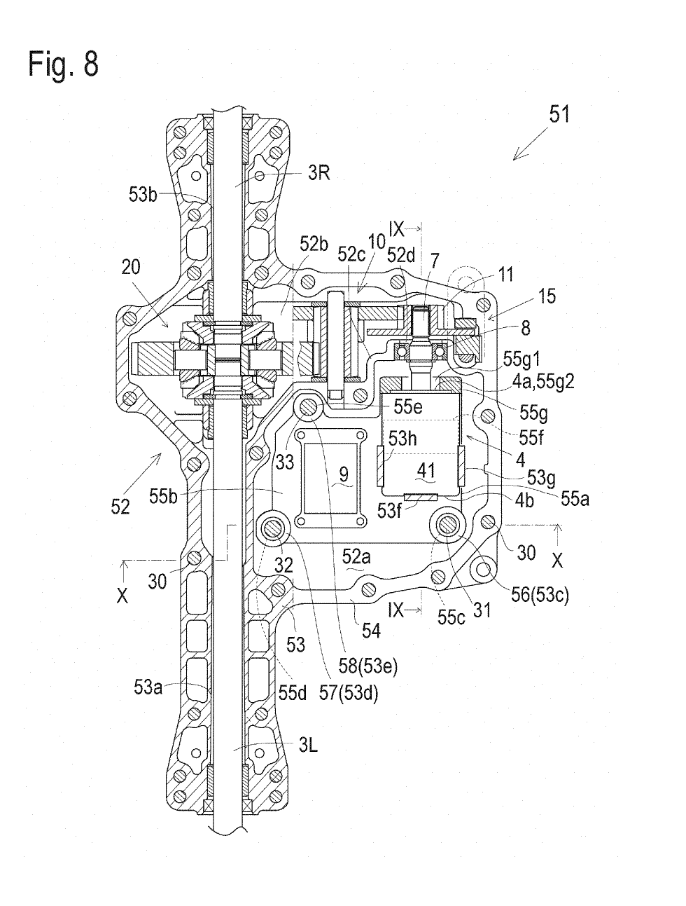

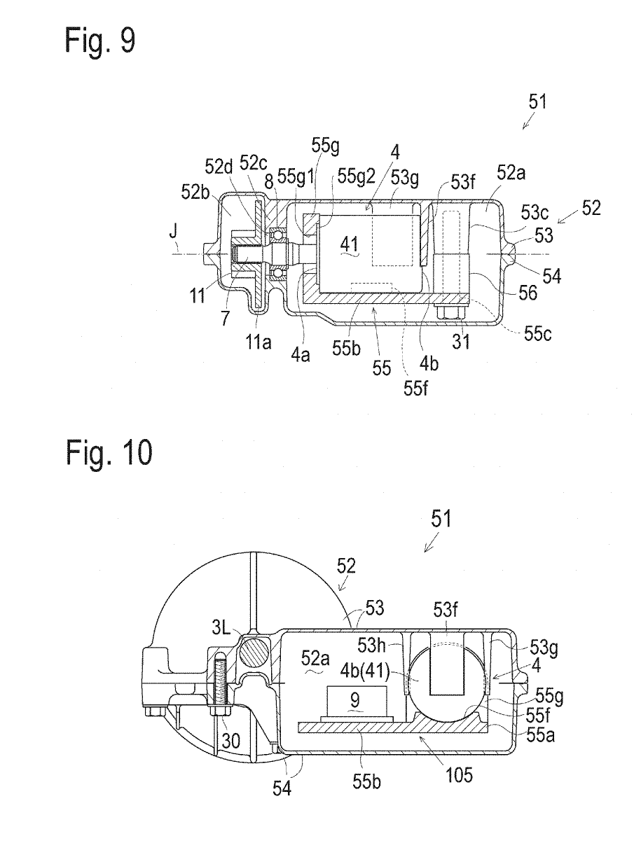

Next, transaxle 51 shown in FIG. 8 to FIG. 10, which is the second embodiment of an electric transaxle applicable as a transaxle for snow remover 100, will now be described herein.

A transaxle casing 52 of transaxle 51 is formed by joining an upper housing 53 and a lower housing 54 at horizontal joint plane J, and then tightening with bolts 30 upper and lower housings 53 and 54. In transaxle casing 52, in a similar layout with which axle holes 21a and 21b, motor chamber 2a, gear chamber 2b, partition wall 2c, and motor shaft hole 2d are arranged in transaxle casing 2, axle holes 53a and 53b, a motor chamber 52a, a gear chamber 52b, a partition wall 52c, and a motor shaft hole 52d are formed. With axle holes 53a and 53b, left and right axles 3L and 3R are journalled. In gear chamber 52b, reduction gear mechanism 10, brake 15, and differential gear mechanism 20 are accommodated in a similar manner as described above.

In motor chamber 52a, in a similar layout with which mounting bosses 21c, 21d, and 21e are arranged in transaxle casing 2, mounting bosses 53c, 53d, and 53e are formed on upper housing 53 so as to be suspended from a ceiling of motor chamber 52a.

Upper housing 53 is further formed with vertical plate-shaped motor support plate portions 53f, 53g, and 53h so as to be suspended from the ceiling of motor chamber 52a. Motor support plate portion 53f extends in a front-back direction. At front and rear of motor support plate portion 53f, motor support plate portions 53g and 53h extend in a horizontal direction in parallel each other.

In transaxle 51, motor support member 55 is used as a member for supporting motor casing 41 of electric motor 4 in motor chamber 52a.

Motor support member 55 is an entirely flat plate material, and formed with bolt holes 55c, 55d, and 55e, similar to bolt holes 5c, 5d, and 5e, so as to be fastened with bolts 31, 32, and 33 to mounting bosses 53c, 53d, and 53e.

Boss members 56, 57, and 58 have each been provided in line with bolt holes 55c, 55d, and 55e, and respectively interposed between mounting bosses 53c, 53d, and 53e and motor support member 55 to fill a height gap between mounting bosses 53c, 53d, and 53e and motor support member 55. However, mounting bosses 53c, 53d, and 53e and motor support member 55 respectively may abut directly by extending mounting bosses 53c, 53d, and 53e longer downwardly, forming, on motor support member 55, upwardly protruded boss portions respectively including bolt holes 55c, 55d, and 55e, or taking other measures.

Similar to electrical component support portion 5b of motor support member 5, motor support member 55 is formed with, in a horizontal direction parallel to joint plane J between housings 21 and 22, an electrical component support portion 55b including a flat electrical component mounting surface 55b1 for attaching relay 9.

On the other hand, electric motor 4 has been supported in transaxle 1 described above in such a manner that motor support member 5 is formed with motor support portion 5a having a smaller width in a horizontal direction and extending in a front-back direction, second end portion 4b of electric motor 4 is engaged into and supported by motor boss portion 5f formed on a left end of motor support portion 5a, while first end portion 4a of electric motor 4 is engaged into and supported by motor mount member 6, instead of motor support member 5, and this motor mount member 6 is locked to partition wall 2c of transaxle casing 2, and, simultaneously, motor output shaft 7 is inserted into motor mount member 6.

In contrast, in transaxle 51, as motor support portion 55a for supporting a bottom end portion of electric motor 4, a rear portion of motor support member 55 is extended in a horizontal direction under electric motor 4, motor support portion 55a is formed with a fitting portion 55f formed to fit an outer peripheral surface of a bottom of motor casing 41 of electric motor 4, fitting portion 55f fits the bottom of motor casing 41 of electric motor 4, and motor support portion 55a supports electric motor 4 from beneath.

Further, a right end of this motor support portion 55a is bent upwardly to form an L shape when viewed from front to form a vertical plate portion 55g, and first end portion 4a of electric motor 4 fits and supports this vertical plate portion 55g. This vertical plate portion 55g is not locked to partition wall 52c of transaxle casing 52, but disposed, away from partition wall 52c, in motor chamber 52a. This vertical plate portion 55g is further formed with a motor shaft hole 55g1. Motor output shaft 7 protruding from first end portion 4a extends rightward from vertical plate portion 55g of motor support member 55 via motor shaft hole 55g1.

As described above, by fitting the bottom of motor casing 41 of electric motor 4 with fitting portion 55f of motor support portion 55a, fitting first end portion 4a of electric motor 4 with vertical plate portion 55g, and disposing motor output shaft 7 so as to pass through motor shaft hole 55g1, electric motor 4 is mounted onto motor support member 55. By installing electric motor 4 and motor support member 55 assembled in such a manner into motor chamber 52a, motor output shaft 7 of electric motor 4 is journalled by motor shaft hole 52d of partition wall 52c of transaxle casing 52 via bearing 8 to extend into gear chamber 52b.

On second end portion 4b of electric motor 4 disposed in motor chamber 52a in such a manner, motor support plate portion 53f formed on upper housing 53 abuts, and, at front and rear of motor support plate portion 53f, motor support plate portions 53g and 53h respectively abut a front end portion and a rear end portion of motor casing 41 of electric motor 4.

When electric motor 4 supported by motor support member 55 is positioned to upper housing 53 in such a manner, bolt holes 55c, 55d, and 55e of motor support member 55 are respectively positioned so as to correspond to bolt holes of mounting bosses 53c, 53d, and 53e of upper housing 53. Thus, by threading respective bolts 31, 32, and 33 into mounting bosses 53c, 53d, and 53e via bolt holes 55c, 55d, and 55e and boss members 56, 57, and 58, motor support member 55 can be fastened to upper housing 53 to finish assembling of electric motor 4 being supported by motor support member 55 into motor chamber 52a.

As described above, in transaxle 51 according to the second embodiment, first end portion 4a of electric motor 4 is locked to vertical plate portion 55g of motor support member 55. Transaxle casing 52 is formed with motor support plate portion 53f parallel to vertical plate portion 55g. Further, second end portion 4b of electric motor 4 is locked to motor support plate portion 53f of transaxle casing 52.

In contrast to transaxle 1 that has required two members, i.e. motor support member 5 and motor mount member 6, for supporting electric motor 4 in motor chamber 2a, transaxle 51 can therefore support electric motor 4 in motor chamber 52a using motor support member 55 only. As a result, the number of components for supporting electric motor 4 can be reduced.

In addition, even though transaxle casing 52 is formed with motor support plate portion 53f (and motor support plate portions 53g and 53h), since, among first end portion 4a and second end portion 4b of electric motor 4, first end portion 4a that is closer to partition wall 52c than second end portion 4b is locked to vertical plate portion 55g of motor support member 55 in motor chamber 52a, partition wall 52c of transaxle casing 52 is not required to be machined for locking first end portion 4a of electric motor 4. As a result, processes for additionally machining a casing of a conventional hydraulic transaxle are prevented from being increased in number, which is advantageous for improved easiness of assembly and cost reduction.

Similar to transaxle 1, in transaxle 51, vertical plate portion 55g of motor support member 55 is formed perpendicular to plate-shaped electrical component support portion 55b, and electrical component mounting surface 55b1 of electrical component support portion 55b is a horizontal surface parallel to joint plane J between upper and lower housings 53 and 54 each other. A shaft center of motor output shaft 7 is also disposed on joint plane J. Effects through this configuration are identical to effects through a configuration similar to a configuration of transaxle 1. In addition, other configurations of transaxle 51 and effects through the configurations are similar to the effects through transaxle 1.

As described above, for transaxle 51 incorporated with an electric motor, according to the second embodiment, a casing of a conventional hydraulic transaxle formed by joining at least two housings (upper and lower housings) can be used as is. As a result, a production cost can be reduced.

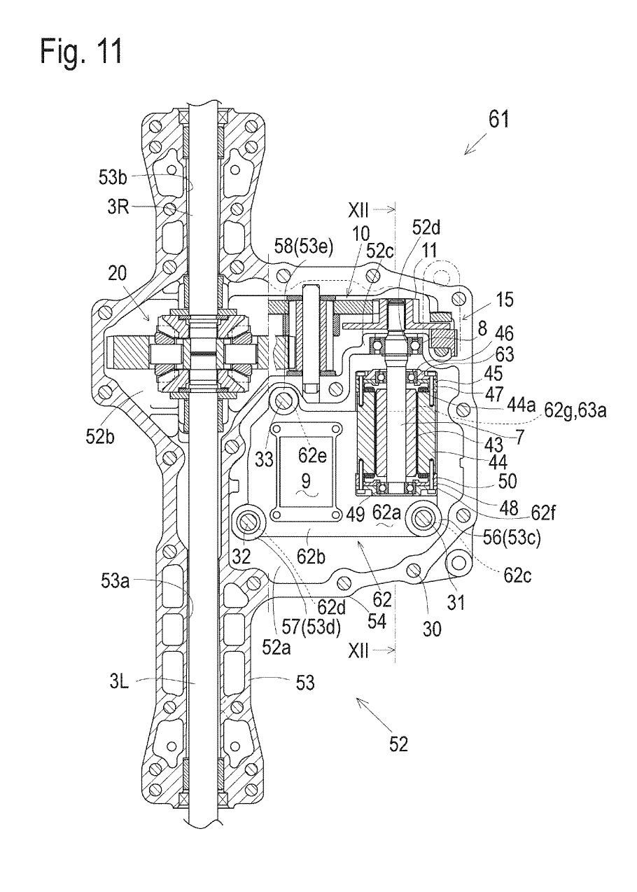

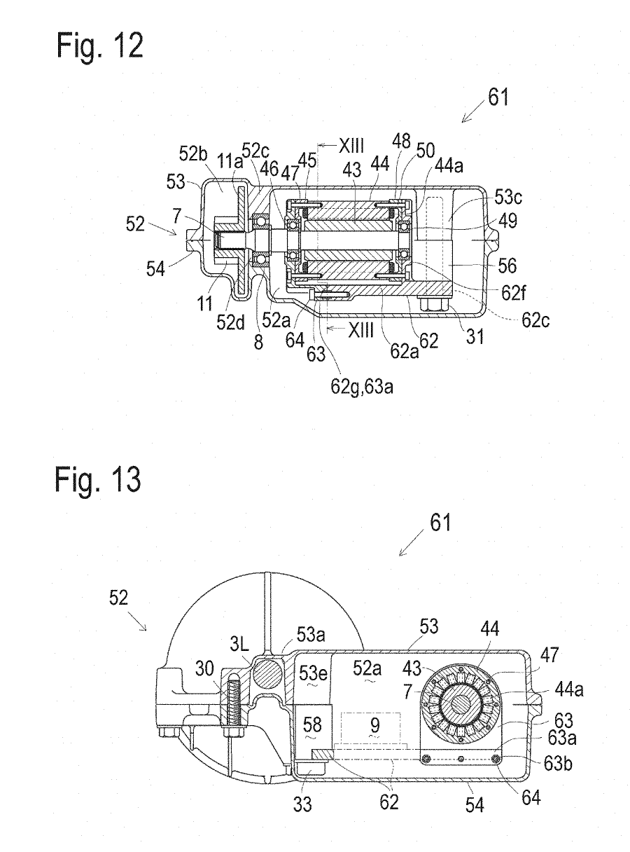

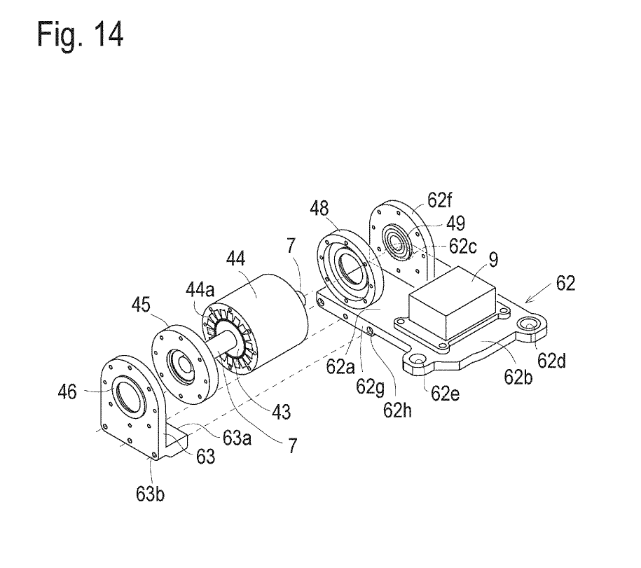

Next, transaxle 61 will now be described herein, as the third embodiment of an electric transaxle shown in FIG. 11 to FIG. 14.

Transaxle 61 uses transaxle casing 52 of transaxle 51. However, transaxle casing 52 of transaxle 51 differs in that vertical plate-shaped motor support plate portions 53f, 53g, and 53h are not formed on upper housing 53.

Transaxle 61 uses electric motor 4, but motor casing 41 is not provided. That is, in electric motor 4 of transaxle 61, rotor 43, i.e. an iron core, is fixed to motor output shaft 7, and cylindrical stator 44 is provided so as to surround rotor 43. Stator 44 is provided with an armature coil 44a.

A ring-shaped end cover 45 is disposed on a right side of stator 44, and, into its center hole, motor output shaft 7 protruding from a right end of rotor 43 is inserted so as to extend into gear chamber 52b.

Bearing support member 63 for supporting a bearing 46 is further disposed on a right side of end cover 45. Motor output shaft 7 protruding from end cover 45 is inserted into this bearing 46. This bearing support member 63 is tightened with bolts 47 to stator 44 together with end cover 45 provided between bearing support member 63 and a right end of stator 44. Thus, end cover 45, bearing 46, bearing support member 63, and other components configure first end portion 4a of electric motor 4.

A ring-shaped end cover 48 is disposed on a left side of stator 44. A left end portion of motor output shaft 7 also protrudes form a left end of rotor 43, and the left end portion of motor output shaft 7 is inserted into a center hole of end cover 48.

A bearing support portion 62f formed on motor support member 62 to be described later is further disposed on a left side of end cover 48 with bearing 49 supported. A left end of motor output shaft 7 protruding from end cover 48 is engaged into this bearing 49. This bearing support portion 62f is tightened with bolts 50 to stator 44 together with end cover 48 provided between bearing support portion 62f and a left end of stator 44. Thus, end cover 48, bearing 49, bearing support portion 62f, and other components configure second end portion 4b of electric motor 4.

Motor support member 62 is an entirely flat plate material, is similar to motor support member 55, and is formed with bolt holes 62c, 62d, and 62e, similar to bolt holes 55c, 55d, and 55e, so as to be fastened with bolts 31, 32, and 33 to mounting bosses 53c, 53d, and 53e via boss members 56, 57, and 58 (or so as to abut directly mounting bosses 53c, 53d, and 53e ). Motor support member 62 is formed with an electrical component support portion 62b for attaching the electrical components including relay 9, similar to electrical component support portion 55b of motor support member 55.

While a front half portion of motor support member 62 forms electrical component support portion 62b, its rear half portion forms a flat motor support portion 62a largely disposed under electric motor 4. This motor support portion 62a is formed with a vertical plate-shaped bearing support portion 62f extended upwardly to configure second end portion 4b of electric motor 4 as described above. A vertical joint surface 62g is formed on a right end of motor support portion 62a, and a bolt hole 62h opens on this joint surface 62g.

On the other hand, a vertical joint surface 63a is formed on a lower end portion of bearing support member 63 so as to face joint surface 62g of motor support member 62. A bolt hole 63b is formed on the lower end portion of bearing support member 63 in a horizontal direction so as to open on this joint surface 63a. By aligning this bolt hole 63b with bolt hole 62h, joint surface 63a and joint surface 62g join. Further, bolts 64 are inserted into bolt holes 63b and 62h, and bearing support member 63 is tightened to motor support member 62.

When assembling electric motor 4, the left end of stator 44 is fixed to bearing support portion 62f of motor support member 62 via end cover 48 or another component. That is, by first configuring second end portion 4b of electric motor 4, joining joint surface 63a of bearing support member 63 with joint surface 62g of motor support member 62, positioning bearing support member 63 onto a right side of electric motor 4, fastening bearing support member 63 with bolts 64 to motor support member 62, and further fixing bearing support member 63 with bolts 47 via end cover 45 to the right end of stator 44, first end portion 4a of electric motor 4 is configured, and thus, assembling electric motor 4 into motor support member 62 completes.

In contrast, by loosening bolts 47 to remove bearing support member 63 from the right end of stator 44, and loosening bolts 64 to remove bearing support member 63 from motor support member 62, first end portion 4a of electric motor 4 can be disassembled. After that, by loosening bolts 50 or taking other measures to remove stator 44 from bearing support portion 62f, second end portion 4b of electric motor 4 can easily be disassembled.

As described above, electric motor 4 used in transaxle 61 does not use motor casing 41. This means that, since stator 44 and rotor 43 can easily be exposed by disassembling members configuring first end portion 4a and second end portion 4b, maintenance operations can be simplified.

Tasks including disassembling of first end portion 4a of electric motor 4, separation of bearing support member 63 from motor support member 62, and further disassembling of second end portion 4b of electric motor 4 can be carried out while motor support member 62 is fastened with bolts 31, 32, and 33 to upper housing 53. Thus, without installing or removing motor support member 62 into or from upper housing 53, electric motor 4 can only be disassembled. This feature can also enhance easiness of maintenance.

Furthermore, bearing support member 63, end cover 45, and other components configuring first end portion 4a are not locked to transaxle casing 52, and can be handled separately from transaxle casing 52. Therefore, by loosening bolts 31, 32, and 33, and removing from upper housing 53 motor support member 62 being fastened to bearing support member 63, electric motor 4 with first end portion 4a and second end portion 4b configured by bearing support member 63 and motor support member 62 can be removed as a set from transaxle casing 2. Therefore, outside transaxle casing 2, electric motor 4 can easily be assembled or disassembled.

As described above, in transaxle 61 according to the third embodiment, second end portion 4b of electric motor 4 is locked to plate-shaped bearing support portion 62f of motor support member 62. In addition, transaxle 61 includes bearing support member 63 including a vertical plate-shaped portion parallel to bearing support portion 62f of motor support member 62. Bearing support member 63 is separably connected to motor support member 62, and disposed in motor chamber 52a. First end portion 4a of electric motor 4 is locked to the vertical plate-shaped portion of bearing support member 63.

As described above, since the vertical plate-shaped portion (including bearing support portion 62f) is formed for locking first and second end portions 4a and 4b of electric motor 4 to motor support member 62 and bearing support member 63, partition wall 52c of transaxle casing 52 is not required to be machined for locking first end portion 4a of electric motor 4. As a result, processes for additionally machining a casing of a conventional hydraulic transaxle are prevented from being increased in number, which is advantageous for improved easiness of assembly and cost reduction.

Separably connecting motor support member 62 including bearing support portion 62f and electrical component support portion 62b, and bearing support member 63 including a vertical plate-shaped portion allows electric motor 4 to be removed easily from motor support member 62 and bearing support member 63 by separating bearing support member 63 from motor support member 62 when removing electric motor 4 from motor chamber 52a for maintenance or other purposes. This feature contributes to improved easiness of maintenance.

Similar to transaxle 1 and transaxle 51, in transaxle 61, bearing support portion 62f of motor support member 62 is formed perpendicular to plate-shaped electrical component support portion 62b, and a surface used for attaching electrical components on electrical component support portion 62b is a horizontal surface parallel to joint plane J between upper and lower housings 53 and 54 each other. A shaft center of motor output shaft 7 is also disposed on joint plane J. Effects through this configuration are identical to effects through a configuration similar to the configuration of transaxle 1 and a configuration of transaxle 51. In addition, other configurations of transaxle 61 and effects through the configurations are similar to the effects through the configurations of transaxle 1 and transaxle 51.

As described above, for transaxle 61 incorporated with an electric motor, according to the third embodiment, a casing of a conventional hydraulic transaxle formed by joining at least two housings (upper and lower housings) can be used as is. As a result, a production cost can be reduced.

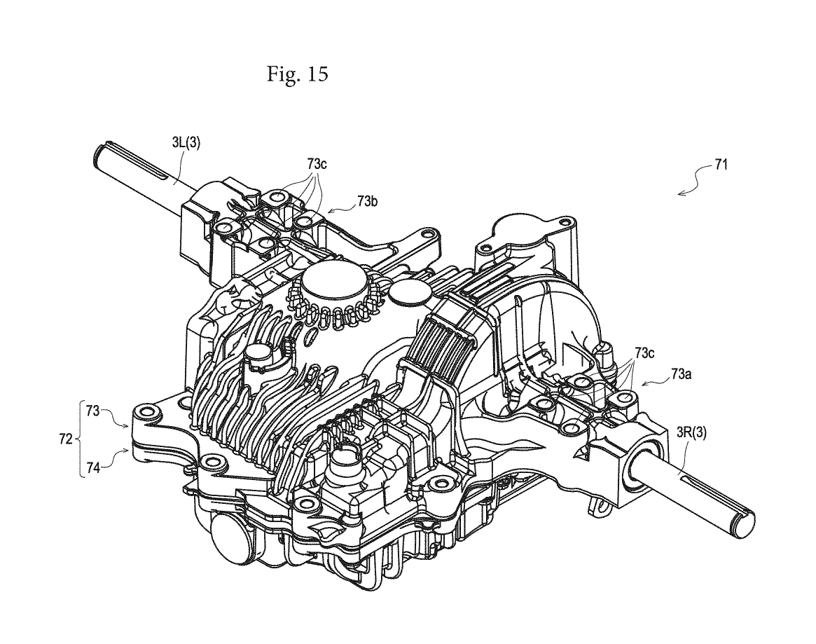

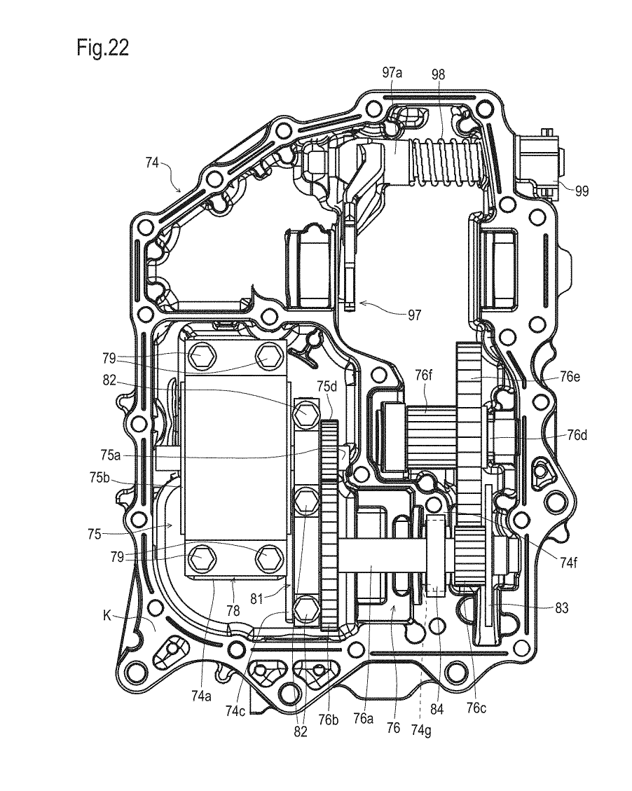

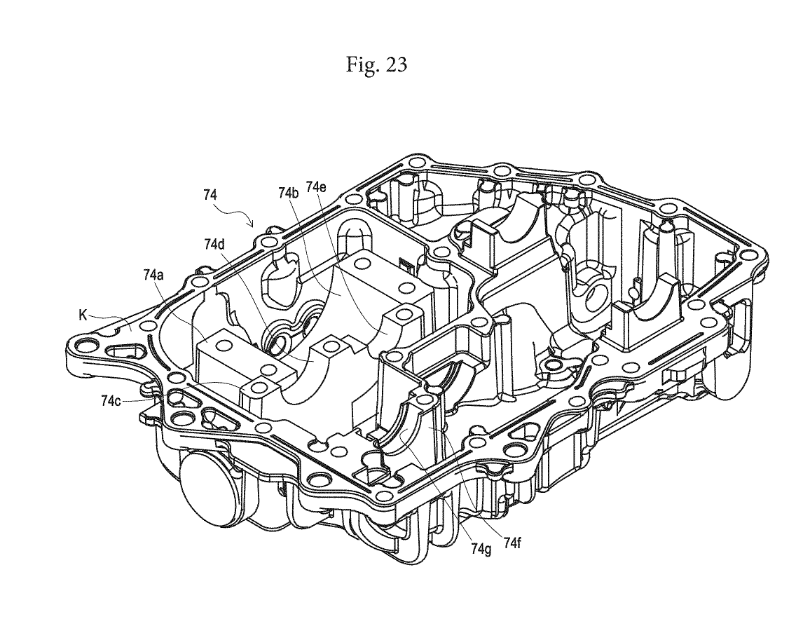

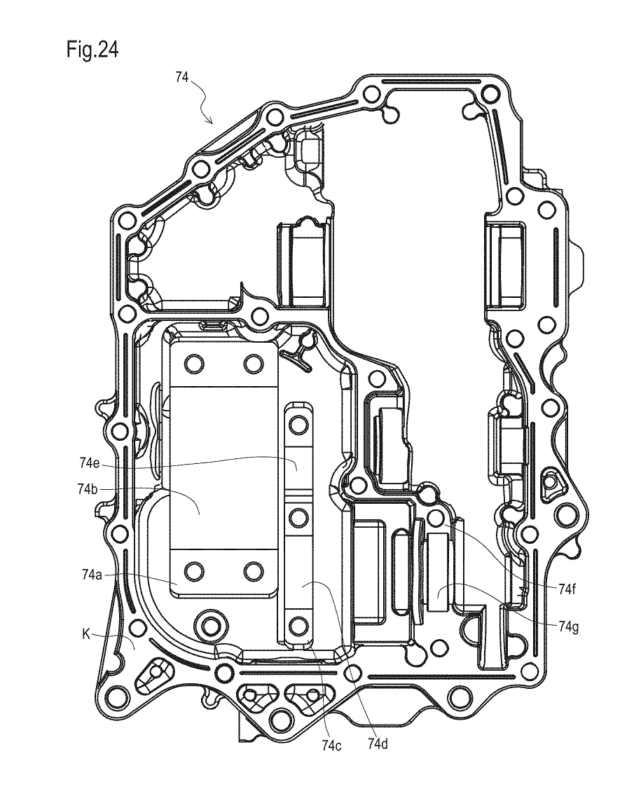

Next, a transaxle 71 as a fourth embodiment of the electric transaxle shown in FIG. 15 to FIG. 25 will be described.

As shown in FIG. 15, a transaxle casing 72 is used for the transaxle 71. As shown in

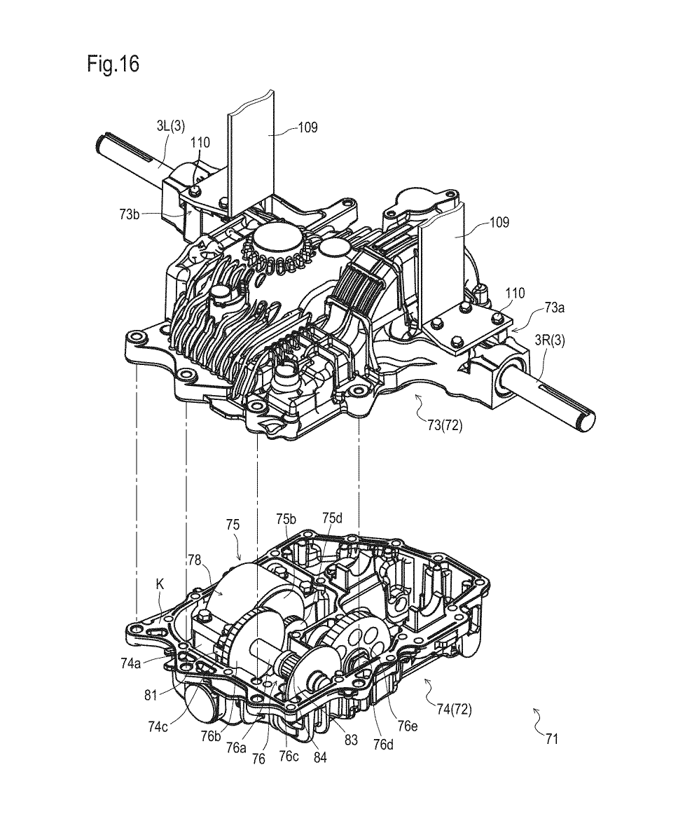

FIG. 15 and FIG. 16, the transaxle casing 72 includes an upper housing 73 which is a first casing and a lower housing 74 which is a second casing.

When the transaxle casing 72 is mounted on a work vehicle such as a snow remover 100 (see FIG. 1), the upper housing 73 forms an upper side of the transaxle casing 72, and the lower housing 74 forms a lower side of the transaxle casing 72. The transaxle casing 72 is configured such that the upper housing 73 and the lower housing 74 can be separated and coupled at a joint plane K. The transaxle casing 72 is configured as a dedicated casing configured to incorporate an electric motor, which is different from the transaxle casings 2, 52 and 62 described above.

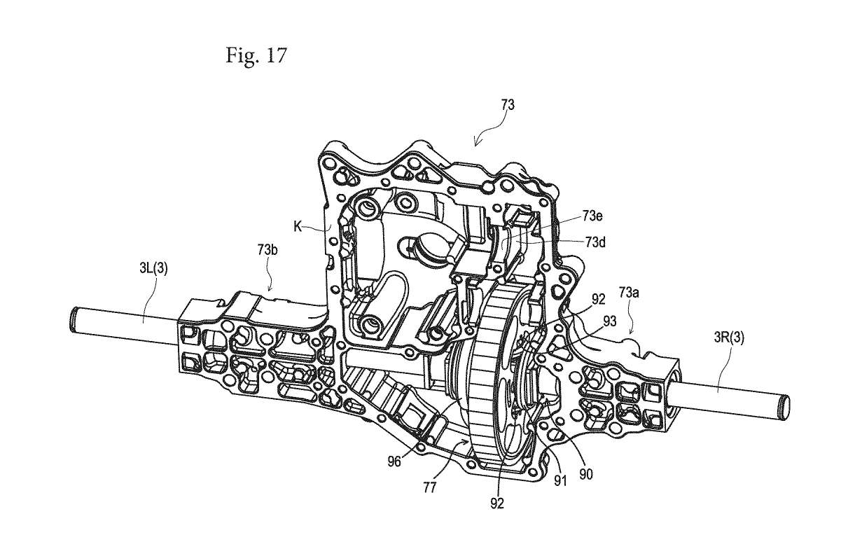

In the transaxle 71, an electric motor 75, a reduction gear train 76, and a bull gear 77 (refer to FIG. 17) are accommodated in the transaxle casing 72.

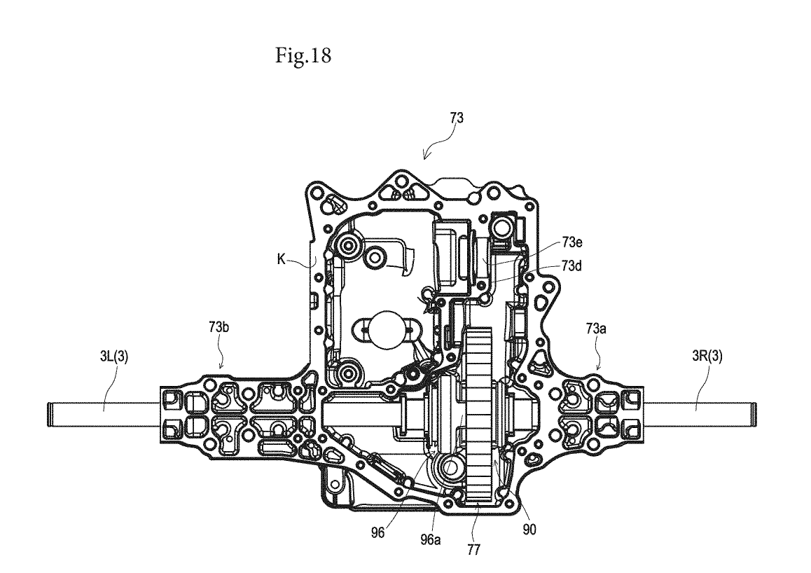

More specifically, in the transaxle 71, a pair of left and right axles 3L and 3R is supported by the upper housing 73 forming the upper side of the transaxle casing 72, and the bull gear 77 is supported by the axles 3L and 3R as shown in FIG. 17 and FIG. 18.

That is, the pair of left and right axles 3L and 3R and the bull gear 77 are completely supported by the upper housing 73 and are independent of the lower housing 74 in the transaxle 71.

As shown in FIG. 15 and FIG. 16, the upper housing 73 includes left and right mount portions 73a and 73b formed to attach the transaxle casing 72 to a vehicle body frame 109 of the snow remover 100 (see FIG. 1). Each of the mount portions 73a and 73b is configured using one set of four mounting bosses 73c, and a bolt hole is formed in each of the mounting bosses 73c. The upper housing 73 is fastened to the vehicle body frame 109 by screwing bolts 110, respectively, to the mounting bosses 73c of the mount portions 73a and 73b.

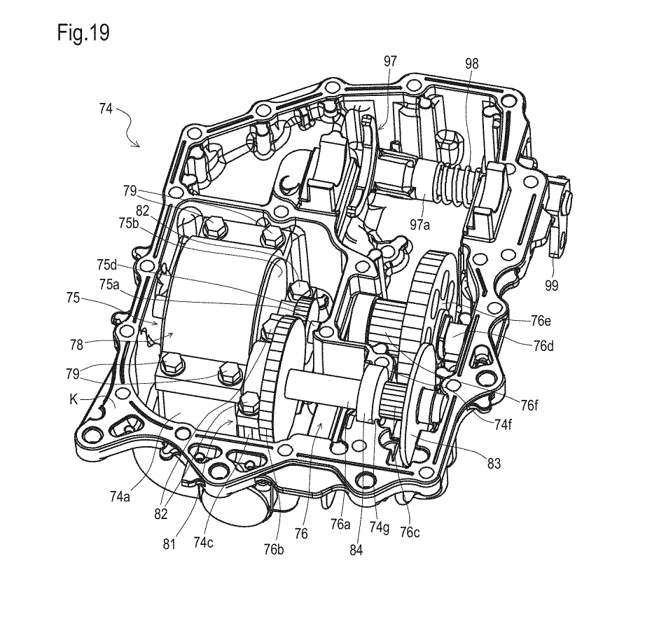

As shown in FIG. 19, the electric motor 75 and the reduction gear train 76 are supported by the lower housing 74 forming the lower side of the transaxle casing 72 in the transaxle 71.

That is, the electric motor 75 and the reduction gear train 76 are completely supported by the lower housing 74 and are independent of the upper housing 73 in the transaxle 71.

As shown in FIG. 19 to FIG. 22, in the transaxle 71, the electric motor 75 not including a motor casing is used, and a motor output shaft 75a for taking out the rotation of a rotor and a cylindrical stator 75b are provided. A motor output gear 75d configured to transmit a rotational output of the electric motor 75 to the reduction gear train 76 is provided at a distal end portion of the motor output shaft 75a.

The reduction gear train 76 is a gear train configured to reduce the rotational output of the electric motor 75 and then transmit the rotational output to the bull gear 77, and includes an input gear 76b and an output gear 76c fixed on a gear shaft 76a, and a large diameter counter gear 76e and a small diameter counter gear 76f provided on a counter shaft 76d. In the reduction gear train 76, the input gear 76b is engaged with the motor output gear. In the reduction gear train 76, the small diameter counter gear 76f is engaged with the bull gear 77. A brake disk 83 which forms a brake mechanism is fixed to the gear shaft 76a.

With such a configuration, the rotational output of the electric motor 75 output from the motor output gear 75d is transmitted to the reduction gear train 76 from the input gear 76b, and is transmitted to the axles 3L and 3R through the output gear 76c, the large diameter counter gear 76e, the small diameter counter gear 76f, and the bull gear 77.

As shown in FIG. 19 to FIG. 24, the lower housing 74 includes a motor base portion 74a formed to support the electric motor 75. The motor base portion 74a has a curved recess 74b having a curvature substantially identical to an outer peripheral surface of the stator 75b of the electric motor 75. Further, a motor holding member 78 configured to fix the electric motor 75 to the lower housing 74 is configured to be attachable to the motor base portion 74a by bolts 79. The motor holding member 78 has a curved recess 78a having a curvature substantially identical to the outer peripheral surface of the stator 75b of the electric motor 75. When the motor holding member 78 is fixed to the motor base portion 74a by the bolts 79, a substantially columnar space for supporting the stator 75b is formed by the recess 74b and the recess 78a, and the stator 75b disposed in the space can be clamped by the motor base portion 74a and the motor holding member 78.

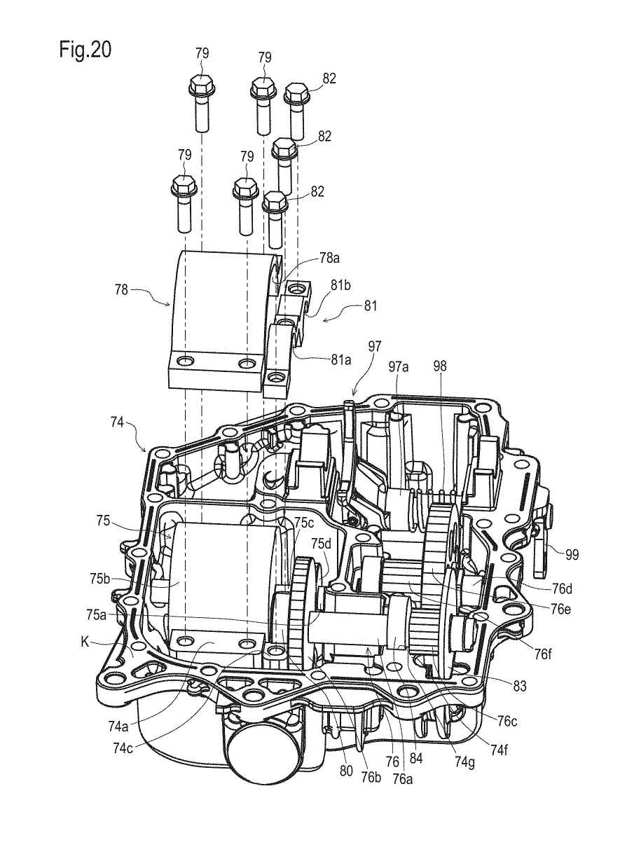

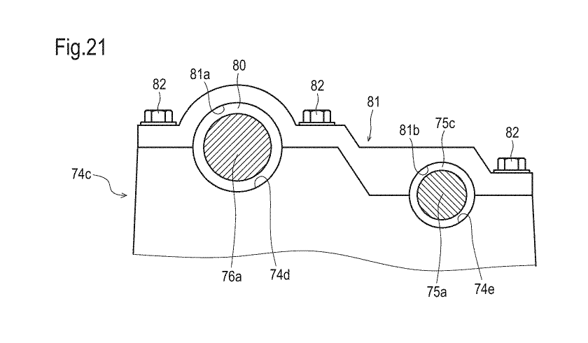

As shown in FIG. 20 and FIG. 21, the lower housing 74 includes a bearing base portion 74c formed to support a bearing 75c of the motor output shaft 75a and support a bearing 80 of the gear shaft 76a in the reduction gear train 76. The bearing base portion 74c has curved recesses 74d and 74e having curvatures substantially identical to outer peripheral surfaces of the bearing 75c and the bearing 80, respectively. Further, a bearing holding member 81 configured to fix the bearing 80 to the lower housing 74 is configured to be attachable to the bearing base portion 74c by bolts 82. The bearing holding member 81 has curved recesses 81a and 81b having curvatures substantially identical to the outer peripheral surfaces of the bearing 75c and the bearing 80, respectively. When the bearing holding member 81 is fixed to the bearing base portion 74c by the bolts 82, a substantially columnar space is formed by the recesses 74d, 81a, 74e, and 81b, and the bearings 80 and 75c disposed in the space can be clamped by the bearing base portion 74c and the bearing holding member 81.

The lower housing 74 includes a bearing base portion 74f formed to support a bearing 84 of the gear shaft 76a in the reduction gear train 76. The bearing base portion 74f has curved recesses 74g having curvatures substantially identical to outer peripheral surfaces of the bearing 84. Further, as shown in FIG. 17 and FIG. 18, the upper housing 73 includes a bearing base portion 73d formed to support a bearing 84 of the gear shaft 76a in the reduction gear train 76. The bearing base portion 73d has curved recesses 73e having curvatures substantially identical to outer peripheral surfaces of the bearing 84. When the upper housing 73 is fixed to lower housing 74, a substantially columnar space is formed by the recesses 73e and 74g, and the bearings 84 disposed in the space can be clamped by the bearing base portion 73d and 74f.

As described above, the electric motor 75 and the reduction gear train 76 are completely supported by the lower housing 74 independently of the upper housing 73 in the transaxle 71.

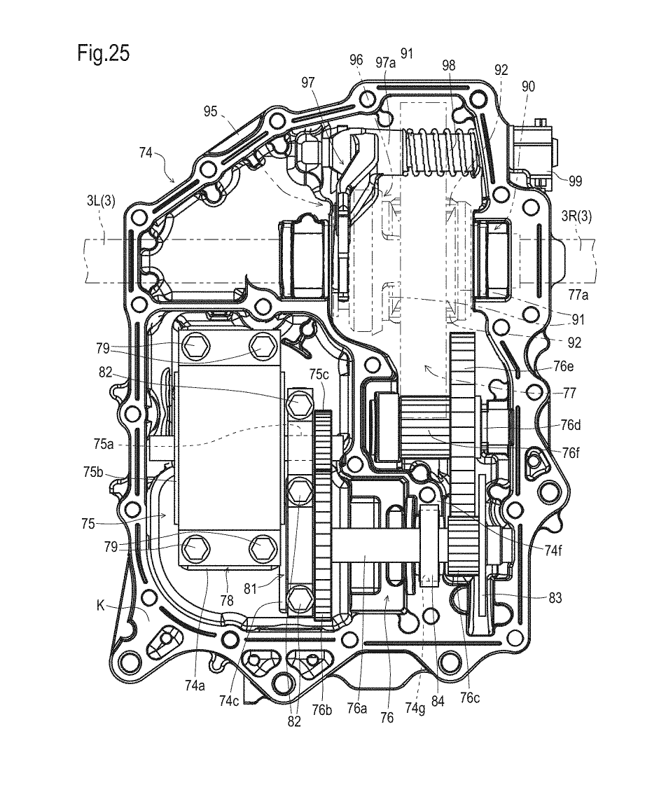

As shown in FIG. 17 and FIG. 25, the left and right axles 3L and 3R are coupled in a differential manner via a differential gear mechanism 90 in the transaxle 71. The differential gear mechanism 90 is formed by combining the bull gear 77, a pair of left and right bevel differential side gears 91, and a pair of front and rear bevel differential pinions 92.

As shown in FIG. 17, as usual, a shaft hole is provided in a horizontal direction at a center of the bull gear 77, and inner end portions of the left axle 3L and the right axle 3R are engaged into the shaft hole. Along the left and right side faces of the bull gear 77, the bevel differential side gears 91 are respectively fixed on the left and right axles 3L and 3R. On the bull gear 77, a pair of pinion holes is symmetrically formed around the shaft hole at the center of the bull gear 77, and on each of the pinion holes, the bevel differential pinions 92 are respectively pivot-supported via pinion shafts 93 and 93. The bevel differential pinions 92 respectively engage the left and right bevel differential side gears 91. The differential gear mechanism 90 also includes a differential lock mechanism 95.

As shown in FIG. 17 and FIG. 25, the differential lock mechanism 95 is configured such that a differential lock slider 96, capable of coupling and non-coupling the bull gear 77 to one side of the bevel differential side gear 91 so as to be relatively non-rotatable, is accommodated in the upper housing 73, and a differential lock fork 97 which locks the differential lock slider 96 and an unlock spring 98 are accommodated in the lower housing 74.

When the transaxle 71 configured as described above is separated into the upper housing 73 side and the lower housing 74 side at the joint plane K, the respective axles 3L and 3R and the bull gear 77 are supported on the upper housing 73 side, and the electric motor 75 and the reduction gear train 76 are supported on the lower housing 74 side. Thus, the transaxle 71 can be easily separated into the upper housing 73 side and the lower housing 74 side at the joint plane K.

As shown in FIG. 16, only the lower housing 74 can be separated from the transaxle 71 in a state where the upper housing 73 is mounted on the vehicle body frame 109. Since the electric motor 75 and the reduction gear train 76 are supported by the lower housing 74 separated in this manner, it is possible to easily perform maintenance of the electric motor 75 and the reduction gear train 76.

As described above, the transaxle 71 incorporating the electric motor according to the fourth embodiment is configured such that it is possible to easily separate and join the transaxle casing 72 in the configuration provided with the transaxle casing 72 formed by joining the two housings (upper and lower housings 73 and 74), thereby improving the assembling work and the removal work of the respective parts of the electric motor 75, the reduction gear train 76, and the bull gear 77, and the maintenance of the inside.

In the transaxle 71, the electric motor 75 is completely supported inside the lower housing 74 by the motor base portion 74a formed on the lower housing 74 and the motor holding member 78 detachably fixed to the motor base portion 74a.

Further, the gear shaft 76a of the reduction gear train 76 is completely supported inside the lower housing 74 by the bearing base portion 74c formed on the lower housing 74 to hold the gear shaft 76a and the bearing holding member 81 detachably fixed to the bearing base portion 74c.

The transaxle 71 configured in this manner can assemble the electric motor 75 and the reduction gear train 76 to the lower housing 74 without worrying about the alignment of the upper housing 73 and the lower housing 74, and thus, it is possible to facilitate the assembling work of the electric motor 75 and the reduction gear train 76. Since the electric motor 75 and the reduction gear train 76 can be removed by jacking up while leaving a tire on the work vehicle only by separating the upper housing 73 and the lower housing 74, it is possible to facilitate the removal work.

If the work vehicle is a zero turn type, the above configuration may be changed to a configuration in which only one axle is supported by the upper housing 73 and the bull gear 77 is directly installed on this one axle to be relatively non-rotatable. If a position of the bull gear 77 in the upper housing 73 is set to coincide between the specification having the differential gear mechanism and the specification having no differential gear mechanism, it is possible to share the lower housing 74 incorporating the electric motor.

It is further understood by those skilled in the art that the foregoing description is given to preferred embodiments of the disclosed apparatus and that various changes and modifications may be made in the invention without departing from the scope thereof defined by the following claims.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A transaxle comprising:
a casing;
an axle accommodated in the casing;
an electric motor accommodated in the casing;
a reduction gear train accommodated in the casing and transmitting an output of the electric motor to the axle; and
a bull gear provided on the axle and coupled to the reduction gear train,
wherein the casing is configured such that a first casing and a second casing are separated and joined at a joint plane parallel to the axle,
the bull gear and the axle are supported in the first casing, and
the electric motor and the reduction gear train are supported in the second casing.

2. The transaxle according to claim 1,
wherein the axle includes a pair of left and right axles coupled in a differential manner by a differential gear mechanism provided on a rotational axis of the bull gear.

3. The transaxle according to claim 1,
wherein the first casing is an upper housing which includes a mounting boss configured to attach the casing to a vehicle body and forms an upper side, and
the second casing is a lower housing which forms a lower side.

4. The transaxle according to claim 1,
wherein the electric motor is completely supported inside the second casing by a motor base portion formed in the second casing to hold the electric motor and a motor holding member detachably fixed to the motor base portion.

5. The transaxle according to claim 1,
wherein a gear shaft of the reduction gear train is completely supported inside the second casing by a bearing base portion formed on the second casing to hold the gear shaft and a bearing holding member detachably fixed to the bearing base portion.
